(19) United States
(12) Patent Application Publication
(10) Pub. No.: US 2004/0166211 A1
(43) Pub. Date: Aug. 26, 2004

(54) Shellac-based film coatings containing pearlescent pigments and edible articles coated therewith

(76) Inventors: Pamela K. Gesford, Harleysville, PA (US); Diane C. Kunkle, Coopersburg, PA (US)

Correspondence Address: MUSERLIAN AND LUCAS AND MERCANTI, LLP, 475 PARK AVENUE SOUTH, NEW YORK, NY, 10016, US

(21) Appl. No.: 10/778,564

(22) Filed: Feb. 13, 2004

Related U.S. Application Data
(60) Provisional application No. 60/448,947, filed on Feb. 20, 2003.

(51) Int. Cl. A23L 1/00

(52) U.S. Cl. 426/273

(57) ABSTRACT

Foods and confections having a pearlescent outer coating and enhanced visual appeal are disclosed. In certain preferred aspects, the shellac-based coatings include from about 10 to about 73% by weight of an edible shellac-based vehicle, from about 5 to about 75% by weight of a denatured alcohol, from about 2 to about 30% by weight of a pearlescent pigment, from about 0.5 to about 10% by weight of a surfactant and from about 0.5 to about 6.0% by weight of a cellulosic polymer.

### CROSS-REFERENCE TO RELATED APPLICATIONS

This application claims the benefit of priority from U.S. Provisional Patent Application No. 60/448,947, filed Feb. 20, 2003, the contents of which are incorporated herein by reference.

### BACKGROUND OF THE INVENTION

1. Field of the Invention

The present invention relates to film coatings having improved pearlescent qualities. The invention also relates to edible substrates such as candies or foods which have been film coated with the improved pearlescent film coatings and methods of preparing the same.

2. Description of the Prior Art

In recent years, efforts have been made to increase the visual appeal of various edible articles. Competition among food and confectionery manufacturers is intense. Each tries to differentiate their goods from those of other manufacturers as a way of building brand loyalty and/or increasing market share among consumers. Moreover, manufacturers are often able to obtain a premium price for goods which have a unique or highly elegant appearance. Briefly stated, manufacturers are constantly striving to come up with innovations which have increased subjective appeal to consumers.

The candy and confectionery arts have proposed increasing visual appeal using various techniques. For example, various shellacs and film coatings have been proposed which provide substrates with a bright or highly polished finish coat. More recently, the food industry has attempted to introduce a pearlescent or nacreous quality to the outer surface of foods and confections as a means of increasing visual appeal to consumers. One such product line which is useful in edible products is sold under the trade name Candurin® by Merck KGaA. The pearlescent pigments are titanium oxide and/or iron oxide pigments supported on a base of lamellar substrate comprising mica or flakes of Al₂O₃, SiO₂ or TiO₂.

PCT patent application having publication number WO 00/03609 discloses coated articles prepared using Candurin pearlescent pigments. The published document discloses that coating materials which can include the pearlescent pigments are sugars, shellacs (both aqueous and ethanolic), polymethacrylates and “cellulose types” including specifically HPMC and Sepifilm® LP (HPMC, MCC and stearic acid). Articles coated with the pearlescent coatings include sugar products (e.g. caramel), cake decorations, chewing gum, chocolate, ice cream, cereals, snack products, nonpareils, gelatin products, candy, licorice, icing, cream compositions, tablets and capsules. There is no disclosure, however, regarding how the surface of the article to be coated affects the quality of the pearlescent coating or what treatments could be applied to the surface of the article in order to obtain a high gloss pearlescent coating.

Product literature promoting the use of Candurin pearlescent pigments for sugar coated panned (pan coated) products instructs customers that the products to be colored with the product should have a dust free smooth surface and that pre-treatment with other glazing agents is not necessary. In spite of these teachings and those provided in WO 00/03609, further improvements have been sought. For example, it has been found that it would be desirable to provide a higher gloss finish on articles containing pearlescent coatings. In addition, contrary to what was taught in the above mentioned product literature, it has been found that the presence of certain subcoats on food substrates does indeed provide unexpected improvements in the appearance of pearlescent coated products, especially when pan coating is employed.

There have also been attempts to improve the stability of shellac-based coatings containing pearlescent pigments. Specifically, manufacturers have been unable to significantly reduce the amount of settlement of such pigments in fully formulated shellac products. Such settlement of the pigments is known in the art as “hard packing”. Re-dispersion of the pigment is difficult or impossible. Products with appreciable amounts of hard packing do not provide elegant final products. Thus, manufacturers typically offer shellac-based coating systems without pigment and instruct their customers to add the pigments to the shellacs prior to the pan coating run. This however adds time and labor expense to the coating process. It would therefore be an advance in the art if fully formulated pigment-containing shellac systems could be provided which resist hard packing.

In addition, if the pigment is improperly suspended, variations in the amount of pigment applied to article to be coated can occur. Also, the distribution of the surface coating is dependent on the ability to flow and form a thin film. If the coating has too much pigment, it will not flow properly and will not have the pearly appearance desired. A still further problem to avoid is the batch to batch color variability which occurs when pigment is added separately. The present invention addresses these and other needs.

### SUMMARY OF THE INVENTION

In one aspect of the invention there are provided shellac based coating systems containing pearlescent pigments. Preferred suspensions for coating edible substrates include from about 10 to about 73% by weight of an edible shellac-containing vehicle, from about 5 to about 75% by weight of a denatured alcohol, from about 2 to about 30% by weight of a pearlescent pigment, from about 0.5 to about 10% by weight of a surfactant and from about 0.5 to about 6.0% by weight of a cellulosic polymer. In certain preferred embodiments, the cellulosic polymer includes a hydroxypropylcellulose (HPC). It has been surprisingly found that when certain cellulosic polymers such as HPC are included in the formulation, hard packing of the pigment can be avoided for extended periods of time. This provides the artisan with the ability of making fully formulated systems to be made in advance and avoiding all of the shortcomings mentioned above. Methods of preparing the shellacs, methods of coating edible articles with the shellac and the coated articles made thereby are also included as features of the invention.

A further aspect of the invention includes an alternative method of coating edible substrates in which a subcoat is applied to the edible substrate before the pearlescent shellac coating is applied. The amount of subcoat applied is preferably in an amount which renders the surface of the edible article substantially smooth but does not materially effect the organoleptic qualities of the article. The subcoat may be a coating composition typically used in coating edible substrates including conventional coatings based on shellac and cellulosic polymers. The subcoat may also be a traditional food coating or glaze. For example, the subcoat may be tempered chocolate, which can be applied to baked goods such as pretzels to produce a very smooth surface prior to coating with the pearlescent coating compositions. The pearlescent coated edible substrates prepared by this alternative method are also part of the invention.

As a result of the present invention, several advantages and improvements over the prior art are realized. For example, the artisan is now able to provide edible food articles with higher degrees of pearlescence and shine.

### DETAILED DESCRIPTION OF THE INVENTION

In one aspect of the invention there are provided shellac-based compositions containing pearlescent pigments for coating edible substrates. Such coating systems broadly contain:

a) from about 10 to about 73% by weight of an edible shellac-containing vehicle;

b) from about 5 to about 75% by weight of a denatured alcohol;

c) from about 2 to about 30% by weight of a pearlescent pigment;

d) from about 0.5 to about 10% by weight of a surfactant; and

e) from about 0.5 to about 6.0% by weight of a cellulosic polymer.

The table below provides preferred and more preferred ranges for these primary ingredients:

| | Preferred | More Preferred |
|---|---|---|
| Ingredient | Range (wt %) | (wt %) |
| edible shellac-containing | 20-60 | 40-50 |
| vehicle | | |
| denatured alcohol | 15-45 | 25-35 |
| pearlescent pigment | 10-30 | 15-25 |
| surfactant | 1-7 | 2-5 |
| cellulosic polymer | 1-5 | 1-3 |

Any food grade or edible shellac-containing vehicle can be used. A non-limiting list of suitable products include any number of the commercially-available confectioner's glazes, resinous glazes, including various weight shellacs cut into ethanol (e.g. 6 lb, 8 lb, etc.), shellacs cut in ammoniated water, or propylene glycol such those available under the Mantrolac name from Mantrose-Haeuser Co.

A key feature of the shellac-based systems of the present invention is that unlike most other shellac-based systems, they can be formulated to include the pigment component and be substantially resistant to the pigment hard-packing thereafter. This has significant advantages over prior art products. As pointed out above, the ability to provide uniform batches of coatings containing readily re-dispersible pigments is a significant improvement. Color quality is maintained and substantially uniform application of the pigment onto the article is readily obtained. The end user also realizes an economic benefit because there is time savings realized by avoiding the steps of adding the pigment to the coating and attempting to avoid the variability of colors from batch to batch. It has been surprisingly found that the addition of an effective amount of a cellulosic polymer, such as hydroxypropylcellulose, prevents the pearlescent pigment from hard packing for time periods of about 90 days or longer under normal packing and storage conditions. For purposes of the present invention, the term “effective amount” shall be understood to be that amount which achieves the desired effect and is generally within the range provided above.

The shellac-based pearlescent coatings can be applied to edible articles by spraying or pan coating the articles. Alternatively, the shellac-based systems can be further diluted with a denatured alcohol to about 20-45% pearlescent shellac in alcohol. Such systems have been found to provide exceptional visual properties on ultra smooth surface articles such as tempered chocolates or those which are typically subcoated. Dripping of the shellac systems onto pan coated articles also provides a dramatic marbled effect which can be controlled by the artisan.

The methods of coating edible substrates using the shellac-based systems can also be modified to include a step of applying a subcoat to the edible article before pearlescent coating is applied. The amount of coatings and subcoatings applied to the edible article in this aspect of the invention will depend upon the needs of the artisan and the articles being coated.

The shellac systems are prepared using standard blending or mixing techniques known to those of ordinary skill. For example, the liquid ingredients such as the shellac and denatured alcohol are individually weighed, added to a suitable apparatus and blended for a sufficient time until a substantially uniform mixture of the ingredients is obtained. The time required to achieve such substantial uniformity will, of course, depend upon the batch size and apparatus used. Next the surfactant, e.g. lecithin, is added and mixed until uniformly dispersed. The dry ingredients e.g. pigment and cellulosic polymer, if included, are added individually and mixed until uniformly dispersed in the mixture.

In an alternative aspect of the invention, the amount of pearlescent pigment employed in the powder mixtures of the invention is an amount which sufficient or effective to impart an improved pearlescent outer coating to the surface of an edible article while the amounts of the remaining ingredients are the same as that set forth above, so long as the total amount of ingredients in sum is 100%.

One of the keys to present invention is the ability to impart improved pearlescence to the surface of edible articles. In this regard, the choice of pearlescent pigment included needs to take into account that the pigment portion should be one which meets or is capable of meeting all government approval requirements for human consumption. In one preferred embodiment of the invention, the pearlescent pigments included are based on titanium dioxide platelets, also known as platy TiO₂, such as those available from Engelhard and/or those described in U.S. Pat. Nos. 5,611,851 and 6,627,212, the disclosures of which are incorporated herein by reference. Such products can be referred to as platelets of titanium dioxide. A non-limiting list of suitable pearlescent platy TiO₂ pigments include green, blue, violet, red, gold, orange, and pearl. See also, for example, Greenstein, L. M. “Nacreous Pigments” Encyclopedia of Polymer Science and Technology, Vol. 10, pp 193-215. Such pigments are available in a wide variety of colors such as reds, golds, violets, greens, etc.

In an alternative aspect of this embodiment, the pearlescent pigment is a micaceous pearlescent pigment such as those available under the trade name Candurin from Merck as mentioned above. See also PCT publication number WO 00/03609, the disclosure of which is incorporated herein by reference. A non-limiting list of suitable pearlescent pigment products include Candurin silver fine, silver sheen, silver luster and sparkle silvers, etc. various “sugar” products like banana sugar or others having a white color and gold, red or blue highlights. Still others include those having various colors, e.g. reds, bronzes, coppers having glitter or luster finishes. Other suitable micaceous pigments are those containing mica coated with titanium dioxide, ferrous oxide, etc. and combinations thereof. The only limitation on the pearlescent pigments included in the powders and other formulations described herein is that they must be capable of being substantially homogeneously combined with the other ingredients and they must be capable of providing a high pearlescent finished coating on the coated, edible article without substantially negatively effecting the organoleptic qualities of the finished product.

The cellulosic polymer can be selected from among the many food grade and/or pharmaceutically acceptable products known to those of ordinary skill. In preferred aspects, however, the cellulosic polymer is a hydroxypropyl-cellulose (HPC).

The surfactant can be selected from among lecithin, stearic acid, polysorbates, monoglycerides, diglycerides and mixtures thereof. More preferably, the surfactant is soya lecithin. Furthermore, the coating systems of the present invention may also include supplemental or auxiliary ingredients such as those typically found in food coatings. A non-limiting list of such adjuvants include colorants, flavorants, suspending agents, supplemental surfactants such as rice bran extract, plasticizers such as PEG 400, pH modifiers such as ammonium hydroxide, anti-foaming agents, etc. and mixtures thereof. The amounts of such adjuvants used will vary of course with the needs of the artisan but will typically be within amounts ranging from about 0.0001 to about 30% by weight. Suitable colorants can be selected from among the food-acceptable ingredients such as FD&C lakes, titanium dioxide,dyes and natural colorants. Secondary film formers, such as sodium alginate, propylene glycol alginate, and polyvinylpyrrolidone, if desired, can also be included.

In a still further embodiment of the invention there is provided a method of coating edible articles or substrates using the shellac-based systems described herein. As will be described in the Examples below, the methods include applying the coating systems/ suspensions to the food articles as part of a pan coating or spray coating process commonly used to coat such articles. The amount of coating applied will depend upon several factors, including the food article to be coated, the amount and color of the pearlescent pigment included in the suspension, the apparatus employed to apply the coating, etc. Mixing or agitation of the pigmented coating suspensions is usually done during spray applications to prevent settling of the suspension and maintain a uniform appearance on the food articles. The suspensions may also be applied in aerosol form. For example, the suspensions may be packaged in an aerosol container designed for home or commercial use by using standard techniques known to those of ordinary skill and applied as a decorative spray on baked goods including cakes, cookies and brownies. In most aspects of the invention, the amount of pearlescent coating applied will be from an amount that is just visually perceptible to about 20% by weight of the coated article, with amounts of from about 0.001 to about 2.0% being preferred.

In order obtain a more visually appealing pearlescent coating on some food articles, especially those which do not have a substantially smooth surface, it may be preferable to apply a subcoat on the food article before the pearlescent coating is applied. The purpose of the subcoat is to provide the food article with an exterior surface which is substantially smooth before the novel pearlescent coatings are applied. While applicants are not bound by theory, it is believed that the visual qualities of the dried pearlescent coat are unexpectedly improved when they are applied to surfaces which are substantially smooth. For purposes of the present invention, a surface which is “substantially smooth” shall be understood to be a surface which is substantially free of rough or coarse areas.

In many aspects of the invention, the subcoat which is applied to the edible article is a confectioner's glaze or other common shellac-based system which can impart a substantially smooth surface to the article prior to the application of the pearlescent systems described herein. In fact, the subcoat can also be part of the edible article to which the pearlescent coating is to be applied. Examples of such products include chocolate panned articles containing a confectioner's glaze.

It should also be noted that in alternative aspects, a subcoat containing a cellulosic polymer such as NaCMC and those described below can be used.

A non-limiting list of suitable subcoatings include those sold under the trade names OPADRY®, OPADRY TYPE F® and OPAGLOS® by Colorcon of West Point, PA. The subcoat may also be free of pigment or include a sufficient amount of a pigment which imparts added luster or visual effect to the pearlescent coating applied to the food article. In most aspects of the invention, the subcoat will be applied to a theoretical weight gain of from about a 0.1 to about a 5%, with amounts of from about 0.5 to about a 3% being preferred.

It shall further be understood that the surfaces to which the inventive suspensions can be applied include baked goods or other products which are porous and absorbent in nature such as cookies, biscuits, etc. In these aspects, the subcoat, plays a particularly important role in allowing the later- applied, pearlescent pigmented coating to achieve it high visual appeal on the baked goods. In will be understood, of course that the subcoat can applied either before or after baking of the goods, depending on its nature, but the pearlescent pigment coat is preferably applied after baking is completed.

The types of edible articles which can be coated with the inventive coating systems is vast. It includes, without limitation, confectionery items, foods, snacks etc. such as tempered chocolates, licorice, pretzels, cookies of all types and other baked goods such as ice cream cones, crackers, enrobed cookies, jelly beans, soft panned items, gumballs, Jordan almonds, various panned confectionery items, chocolate panned nuts, white confectionery coating/yogurt coated products like raisins, caramel pieces, malt balls, smooth hard candies including deposited types, gummy bears or other shapes, molded and enrobed chocolates

### EXAMPLES

The following examples serve to provide further appreciation of the invention but are not meant in any way to restrict the effective scope of the invention.

### Examples 1-6

In these examples, various shellac-based coatings made in accordance with the present invention are set forth:

### Example 1

| | |
|---|---|
| Shellac 6 lb. Cut/in Ethanol | 45.6% |
| SDA 35A Alcohol (27 CFR) | 30.4% |
| Platy TiO₂ pearl (gold) | 20.0% |
| Lecithin (Soya) | 2.0% |
| HPC | 2.0% |
| total: | 100.0% |

### Example 2

| | |
|---|---|
| Shellac 8 lb. Cut/in Ethanol | 40.2% |
| SDA 35A Alcohol (27 CFR) | 35.8% |
| Platy TiO₂ pearl (violet) | 20.0% |
| Lecithin (Soya) | 2.0% |
| HPC | 2.0% |
| total: | 100.0% |

### Example 3

| | |
|---|---|
| Esterified Shellac 6 lb. Cut | 45.6% |
| SDA 35A Alcohol (27 CFR) | 30.4% |
| Platy TiO₂ pearl (Blue) | 18.3% |
| Lecithin (Soya) | 2.0% |
| HPC | 2.0% |
| Propylene Glycol | 1.0% |
| Art. Flavor (Blue Raspberry) | 0.5% |
| FD&C Blue #1 dye | 0.2% |
| total: | 100.0% |

### Example 4

| | |
|---|---|
| Shellac in Ammoniated Water | 63.8% |
| N-Butyl Alcohol | 10.0% |
| Platy TiO₂ pearl (Green) | 15.0% |
| PVP (secondary film former) | 5.0% |
| Lecithin (Soya) | 2.0% |
| HPC | 3.0% |
| FD&C Yellow #5 dye | 0.5% |
| FD&C Blue #1 dye | 0.3% |
| Antifoam Emulsion | 0.2% |
| NH₄OH Reagent (28%)[pH mod.] | 0.2% |
| total: | 100.0% |

### Example 5

| | |
|---|---|
| Shellac 6 lb. Cut/in Ethanol | 38.1% |
| Isopropyl Alcohol | 35.5% |
| Platy TiO₂ pearl(Red) | 20.0% |
| Peg 400 | 2.4% |
| Lecithin (Soya) | 2.0% |
| HPC | 2.0% |
| total: | 100.0% |

### Example 6

| | |
|---|---|
| Shellac 6 lb. Cut/in Ethanol | 45.6% |
| SDA 35A Alcohol (27 CFR) | 30.4% |
| Platy TiO₂ pearl (Orange) | 19.5% |
| Acetylated Monoglyceride | 2.5% |
| NaCMC | 2.0% |
| total: | 100.0% |

In each case, the shellac and SDA alcohol were measured and combined in a mixing bowl. Next, the lecithin was added and mixed until dispersed. The HPC was thereafter added and mixing was continued until the HPC was sufficiently dispersed. The pearlescent pigment was then added and dispersed into the combination of ingredients.

### Example 7

In this example, the coating system of Example 1 was applied onto chocolate pan-coated raisins containing a confectioner's glaze external coating. This coating acted as a subcoating for the pearlescent coating which was ladled by dripping the coating onto the pieces tumbling in a rotating pan until the coating was spread throughout the pan. The pieces were then allow to tray dry overnight. The pearlescent coating was determined to be applied to a weight of about 0.1%, based on the weight of the shellac coating system. The final products demonstrated enhanced pearlescence and shine as compared to the product described below.

### Example 8

In this example, the process of Example 7 was repeated except that the chocolate pan-coated article did not contain a confectioner's glaze prior to the application of the coating system of Example 1. Specifically, chocolate panned almonds were ladle-coated with the coating system of Example 1 to about the same weight gain and then observed for pearlescent appearance and overall finish. It was determined that the final products had effectively no pearlescent qualities and a much duller finish as compared to the products of Example 7.

### Examples 9-10

The processes of Examples 7 and 8 were repeated using chocolate lentils as the edible article. As known to those of ordinary skill, these substrates are hard panned candy covered chocolate pieces which are not film coated and are known to have an external surface which is not generally regarded as being substantially smooth.

In Example 9, the chocolate lentils were coated with a confectioners glaze. The amount added was 0.5% by weight of the lentils. The ladled pearlescent coating of Example 1 was then applied. The amount added was 0.7% by weight of the lentils. The final products were observed to have a bright pearlescent covering with some speckling.

In Example 10, the chocolate lentils were coated directly with the coating system of Example 1. The absence of the subcoat was determined to appreciably reduce the pearlescence of the final product. While applicants are not bound by theory, it is believed that the poorer result is attributable to the unsmooth surface of the lentil to which the inventive coating was applied.

### Example 11

In this Example, the coating system of Example 1 was diluted down to a ratio of 2 parts ethanol to 1 part of the coating system. One part of the diluted coated system was then sprayed onto 100 parts of tempered pieces of chocolate. The resulting final products were pearlescent in appearance, in spite of the absence of the subcoat. The surface of tempered chocolate to which the inventive coating was applied, however, was substantially smooth.

### Example 12

The process of Example 11 was repeated except that the coating system of Example 1 was diluted into isopropyl alcohol. There was no difference in the appearance of the final product.

### Example 13

The process of Example 11 was repeated with the coating system of Example 12 except this time the substrate was tempered chocolate that had been roughened via excessive tumbling and scuffing in a coating pan. The finished product did not appear pearlescent or shiny. However, when 0.25 part of a shellac-based coating (OPAGLOS) was applied to 100 parts of the same roughened chocolate substrates to produce substantially smooth surfaces and the resulting products were subsequently coated with the pearlescent coating system of Example 12, the final products had a shiny gold pearlescent appearance.

### Example 14

The process of Example 7 is repeated using licorice rope pieces as the edible article. The licorice is coated with 0.35% by weight of a confectioner's glaze. The pearlescent coating of Example 1 is sprayed on the pieces and the amount added was 0.5% by weight of the pieces. The final products are observed to have a bright pearlescent covering with some speckling.

### Example 15

In order to demonstrate the ability of the shellac-based coating systems of the present invention to resist hard packing, a comparison was undertaken. A control shellac formulation was made according to the following formula:

| | |
|---|---|
| Shellac 6LB/45 alcohol | 37.654% |
| Ethanol | 35.083% |
| Platy TiO₂ | 24.888% |
| Soya lecithin | 2.375% |
| Total: | 100.00% |

As was the case with the Examples 1-6, the shellac and ethanol were added to a mixer, followed by the lecithin and pigment which were added separately and mixed until dispersed. A portion of the fully formulated batch was then transferred into 120 ml bottles, which were observed periodically to see when hard packing began. After two weeks, it was determined that significant build-up of pigment was found at the bottom of the bottles. This hard packing could not be re-dispersed with agitation or stirring and would thus have a negative effect on the articles coated therewith. This result was surprising because lecithin is recognized as an agent which combats against hard packing. It did not, however, prevent hard packing in coating systems described above.

### Example 16

The coating system of Example 1, which contains HPC was also tested for resistance to hard packing. A portion of the fully formulated batch was then transferred into 120 ml bottles, which were observed periodically to see when hard packing began. After two weeks, it was determined that no significant build-up of pigment was found at the bottom of the bottles. Re-dispersion of the pigment was possible with minimal agitation. Observation was continued for 90 days and then stopped. No hard packing was observed and the pigment was always re-dispersible into the coating system.

### Example 17

To 97 parts of a conventional shellac-based coating system (OPAGLOS), also known as confectioner's glaze, were added 3 parts of the pearlescent coating composition of Example 1. The pearlescent coating system was readily dispersed. This mixture was then applied to smooth, chocolate-coated raisins in accord with typical coating recommendations for confectioner's glaze, i.e. about 3 ounces of the mixture were evenly applied to 100 pounds of chocolate-coated raisins in a rotary pan without the addition of cooling air. Ambient air was was then applied to the product, and the coating pan was “jogged” (i.e. intermittently rotated briefly then stopped) until the product was dry to the touch. The finished product had a transparent, pearlescent gold finish.

While there have been described what are presently believed to be the preferred embodiments of the invention, those skilled in the art will realize that changes and modifications may be made thereto without departing from the spirit of the invention. It is intended to claim all such changes and modifications that fall within the true scope of the invention.

What is claimed is:

1. A suspension for coating edible substrates comprising:
a) from about 10 to about 73% by weight of an edible shellac-containing vehicle;
b) from about 5 to about 75% by weight of a denatured alcohol;
c) from about 2 to about 30% by weight of a pearlescent pigment;
d) from about 0.5 to about 10% by weight of a surfactant; and
e) from about 0.5 to about 6.0% by weight of a cellulosic polymer.

2. The coating suspension of claim 1, wherein said edible shellac-containing vehicle is present in an amount of from about 20 to about 60% by weight.

3. The coating suspension of claim 2, wherein said edible shellac-containing vehicle is present in an amount of from about 40 to about 50% by weight.

4. The coating suspension of claim 1, wherein said denatured alcohol is present in an amount of from about 15 to about 45% by weight.

5. The coating suspension of claim 4, wherein said denatured alcohol is present in an amount of from about 25 to about 35% by weight.

6. The coating suspension of claim 1, wherein said pearlescent pigment is present in an amount of from about 10 to about 30% by weight.

7. The coating suspension of claim 6, wherein said pearlescent pigment is present in an amount of from about 15 to about 25% by weight.

8. The coating suspension of claim 1, wherein said pearlescent pigment comprises titanium dioxide platelets.

9. The coating suspension of claim 1, wherein said pearlescent pigment comprises micaceous pearlescent pigments.

10. The coating suspension of claim 1, wherein said surfactant is present in an amount of from about 1 to about 7% by weight.

11. The coating suspension of claim 10, wherein said surfactant is present in an amount of from about 2 to about 5% by weight.

12. The coating suspension of claim 1, wherein said surfactant is selected from the group consisting of lecithin, stearic acid, polysorbates, monoglycerides, diglycerides and mixtures thereof.

13. The coating suspension of claim 12, wherein said surfactant is soya lecithin.

14. The coating suspension of claim 1, wherein said cellulosic polymer is present in an amount of from about 1 to about 5% by weight.

15. The coating suspension of claim 14, wherein said cellulosic polymer is present in an amount of from about 1 to about 3% by weight.

16. The coating suspension of claim 1, wherein said cellulosic polymer is hydroxpropylcellulose.

17. The coating suspension of claim 1, further comprising a member of the group consisting of colorants, flavorants, supplemental surfactants, suspending agents, plasticizers, pH modifiers and mixtures thereof.

18. A method of coating edible substrates, comprising coating an edible substrate with the coating suspension of claim 1.

19. The pearlescent coated edible substrate prepared by the method of claim 18.

20. A method of coating edible substrates with a pearlescent coating, comprising providing an edible substrate, applying a sufficient amount of a subcoat to said edible substrate in order to provide a substantially smooth outer surface for said edible substrate and thereafter applying the coating suspension of claim 1 thereto.

21. The pearlescent coated edible substrate prepared by the method of claim 20.

22. The method of claim 18, wherein the coating suspension is applied in an amount that is just visibly perceptible to about 20% by weight of the substrate.

23. The method of claim 22, wherein the coating suspension is applied from about 0.001 to about 2.0% by weight of the substrate.

24. The method of claim 20, wherein the coating suspension is applied in an amount that is just visibly perceptible to about 20% by weight of the substrate.

25. The method of claim 20, wherein the subcoat is applied from about 0.1 to about 5% by weight of the substrate.

26. A method of coating edible substrates, comprising diluting the coating suspension of claim 1 into another edible coating system and coating said edible substrates with the mixture.
